(19) United States
(12) Patent Application Publication
(10) Pub. No.: US 2018/0091806 A1
(43) Pub. Date: Mar. 29, 2018

(54) SCREEN IMAGE GENERATION APPARATUS, SCREEN IMAGE GENERATION METHOD, AND SCREEN IMAGE GENERATION PROGRAM

(71) Applicant: OMRON Corporation, Kyoto-shi (JP)

(72) Inventors: Kiyotaka UEDA, Kusatsu-shi (JP); Kayoko ISOGAI, Kyoto-shi (JP)

(73) Assignee: OMRON Corporation, Kyoto-shi (JP)

(21) Appl. No.: 15/480,495

(22) Filed: Apr. 6, 2017

(30) Foreign Application Priority Data
Sep. 27, 2016 (JP) 2016-187747

(51) Int. Cl. H04N 17/00

(52) U.S. Cl. CPC H04N 17/004

(57) ABSTRACT

A screen image generation apparatus includes a screen generation unit, a screen display duration database, and a display duration calculation unit. The screen generation unit generates a screen image to be displayed by an external device. The screen display duration database stores an element display duration for each element included in the screen image. The element display duration is a duration taken by the external device before displaying each element. The display duration calculation unit calculates, using the element display duration, a screen display duration taken by the external device before displaying the generated screen image.

This application claims priority from prior Japanese Patent Application No. 2016-187747 filed with the Japan Patent Office on Sep. 27, 2016, the entire contents of which are incorporated herein by reference.

### FIELD

The present disclosure relates to a technique for generating a screen image to appear on an external display, such as a programmable terminal, used for a factory automation (FA) apparatus.

### BACKGROUND

FA systems described in, for example, Non Patent Literature 1, now have many practical applications. An FA apparatus may use a highly functional display, such as a programmable terminal described in Non Patent Literature 2, which displays information about the connected FA apparatus and controls the operation of the FA apparatus as appropriate.

An operator views the screen image of, for example, a measuring instrument appearing on the programmable terminal and checks the operating status of the FA apparatus. The operator also performs a touch operation on a screen image including buttons appearing on the programmable terminal, and thus controls the operation of the FA apparatus and performs various settings of the FA apparatus.

A method typically used for generating a screen image to appear on the programmable terminal will be described below.

A screen creator operates a device incorporating a screen image generation program, such as a personal computer (PC), to generate a screen image. The screen creator transfers the screen image generated with the PC to a programmable terminal. An intended screen image is thus incorporated into the programmable terminal.

The screen creator debugs an image screen using a simulator that simulates, in the PC, the operation and the display of the programmable terminal.

Another programmable terminal with the structure described in Patent Literature 1 actually displays an externally generated screen image, and displays information about the duration taken before displaying the image on its screen.

The screen image typically includes elements, such as buttons, lamps, measuring instruments, and images. The duration taken before displaying each element is different. To improve operability and visibility, the programmable terminal may have a large screen or may have a high-resolution screen.

The screen creator thus often arranges many elements in a single screen image. The screen creator also often uses user-friendly, functional elements to improve operability. Such elements often take a longer duration before appearing.

### CITATION LIST

### Patent Literature

Patent Literature 1: Japanese Unexamined Patent Application Publication No. 6-186940

### Non Patent Literature

Non Patent Literature 1: OMRON Automation Systems: Machine Automation Controllers, Overview, URL: http://www.fa.omron.co.jp/guide/technicalguide/454/270/index.html
Non Patent Literature 2: OMRON Automation Systems: Programmable Terminals, Overview URL: http://www.fa.omron.co.jp/guide/technicalguide/27/284/index.html

### SUMMARY

In the stage of screen image generation, the screen creator cannot determine the duration to be taken by the programmable terminal before displaying the screen image (the screen display duration taken by the programmable terminal, or the actual duration).

The screen display duration can be determined by, for example, actually displaying the screen image on the programmable terminal described in Patent Literature 1. The screen creator thus cannot determine the screen display duration of a screen image that is currently being generated.

Further, the programmable terminal may include a calculation unit (e.g., a CPU or an MPU) that may operate differently from a calculation unit (e.g., a CPU) included in the PC.

When the PC and the programmable terminal include calculation units that operate differently, the simulation yields the duration to be taken by the programmable terminal before displaying a screen image (the screen display duration taken by the programmable terminal, or the actual duration) that differs from the duration to be taken by the PC before displaying the screen image (the screen display duration taken by the PC, or the simulated duration).

The processing speed of the calculation unit in the programmable terminal is typically lower than the processing speed of the calculation unit in the PC. After the screen creator finds no operational problem during debugging, the operator may find an operational problem when operating the programmable terminal. In this case, the screen creator again generates a screen image to improve operability.

This can occur not only to the PC and the programmable terminal but also to any other screen image generation apparatus and an external device different from the screen image generation apparatus when the processing speed of the calculation unit in the screen image generation apparatus differs from the processing speed of the calculation unit in the external device.

One or more embodiments of the present invention are directed to a technique for allowing a screen image generation apparatus to obtain the actual display duration to be taken by an external device before displaying a screen image.

A screen image generation apparatus according to an aspect of the present invention includes a screen generation unit, a screen display duration database, and a display duration calculation unit. The screen generation unit generates a screen image to be displayed by an external device. The screen display duration database stores an element display duration for an element included in the screen image. The element display duration is a duration to be taken by the external device before displaying each element. The display duration calculation unit calculates, using the element display duration, a screen display duration taken by the external device before displaying the generated screen image.

Accordingly, this structure can allow a screen creator to obtain information about the duration taken before displaying the screen image (screen display duration) determined in accordance with the processing speed of the external device.

In the screen image generation apparatus according to one or more embodiments, the screen generation unit may add the screen display duration to the screen image.

This structure allows the screen creator to visually recognize the screen display duration while generating the screen image.

In the screen image generation apparatus according to one or more embodiments, when detecting that the screen display duration is not less than a preset threshold duration, the display duration calculation unit may output a warning notification to the screen generation unit. The screen generation unit may add the warning notification to the screen image.

This structure allows the screen creator to visually recognize a warning notification indicating that the screen display duration is longer while generating the screen image.

The screen image generation apparatus according to one or more embodiments may further include a display simulation unit that simulates display of the screen image. The display simulation unit may output the screen image after a wait time that is set in accordance with the screen display duration.

This structure simulates display of the screen image using a screen display duration equivalent to the display duration for the programmable terminal, and allows the creator to check the operation and the change in the display equivalent to those in the programmable terminal. The creator can experience the operability of the screen image.

The aspect of the invention can allow the screen creator to obtain the actual duration to be taken before displaying a screen image by an external device different from an apparatus with which he or she is generating the screen image.

### BRIEF DESCRIPTION OF THE DRAWINGS

FIG. 1 is a block diagram showing the main components of a screen image generation apparatus according to a first embodiment of the present invention.

FIG. 2 is a schematic block diagram of a system including the screen image generation apparatus.

FIG. 3 is a diagram showing information stored in a screen display duration database (DB).

FIG. 4A is a schematic diagram showing the structure of a displayed screen for generating a screen image. FIG. 4B is a diagram describing screen image generation in a first state.

FIG. 5A is a diagram describing screen image generation in a second state.

FIG. 5B is a diagram describing screen image generation in a third state.

FIG. 6 is a flowchart showing a screen image generation method according to the first embodiment of the present invention.

FIG. 7 is a flowchart showing a screen image generation method according to a second embodiment of the present invention.

FIG. 8A is a diagram describing screen image generation in a first state with the screen image generation method according to the second embodiment. FIG. 8B is a diagram describing screen image generation in a second state with the method according to the second embodiment.

FIG. 9A is a schematic diagram showing the structure of a displayed screen for generating a screen image. FIG. 9B shows the structure of a display window for groups.

FIG. 10 is a diagram showing information stored in a screen display duration DB according to a third embodiment.

FIG. 11 is a schematic diagram of a tool box window.

FIG. 12 is a block diagram showing the main components of a screen image generation apparatus according to a fourth embodiment of the present invention.

FIG. 13 is a graph showing an example of a file storing a screen display duration TD for each screen image generated by a notification unit.

FIG. 14 is a block diagram of a screen image generation apparatus according to a fifth embodiment of the present invention.

FIG. 15 is a flowchart showing a process for checking a generated screen image according to the fifth embodiment using a simulator.

FIGS. 16A and 16B are diagrams each describing a screen image appearing on a display.

### DETAILED DESCRIPTION

A screen image generation apparatus, a screen image generation method, and a screen image generation program according to a first embodiment of the present invention will now be described.

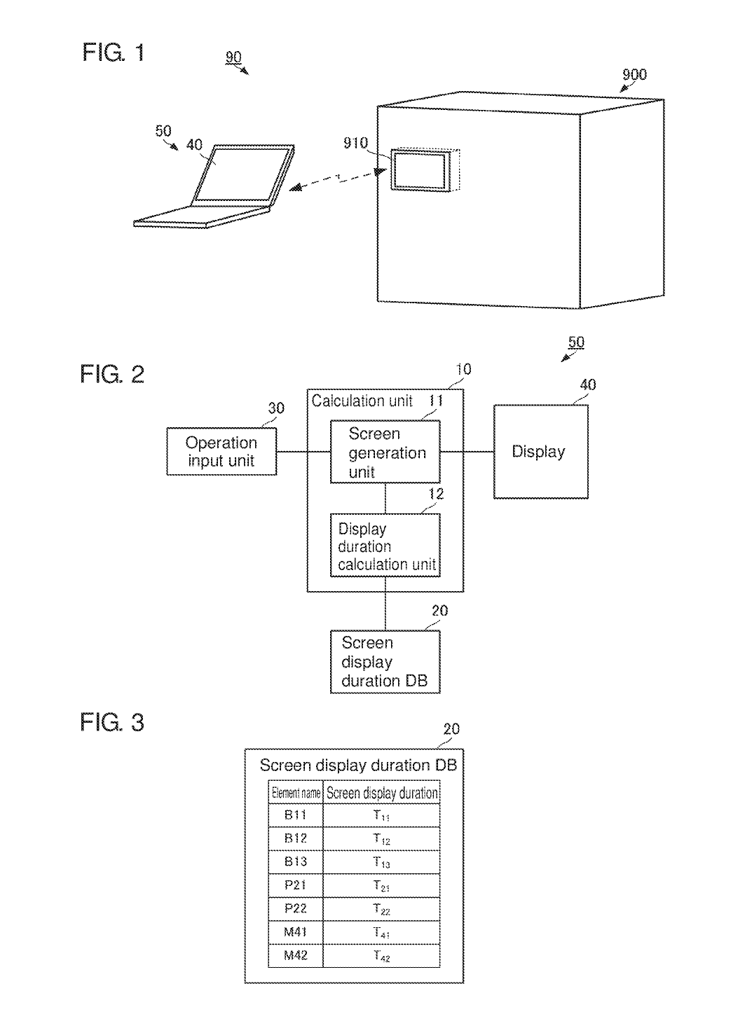

FIG. 1 is a block diagram schematically showing a factory automation (FA) system including the screen image generation apparatus according to the first embodiment. FIG. 2 is a block diagram showing the main components of the screen image generation apparatus according to the first embodiment.

As shown in FIG. 1, an FA system 90 includes a screen image generation apparatus 50 and an FA device 900. The screen image generation apparatus 50 is, for example, a personal computer, and includes a display 40. The FA device 900 includes a programmable terminal 910. The programmable terminal 910 corresponds to an external device of the present invention. The screen image generation apparatus 50 and the programmable terminal 910 are communicable with each other.

The screen image generation apparatus 50 generates a screen image to appear on the programmable terminal 910. The screen image generation apparatus 50 transfers the generated screen image to the programmable terminal 910. The programmable terminal 910 displays the screen image generated by the screen image generation apparatus 50. In other words, the screen image displayed by the programmable terminal 910 is generated by the screen image generation apparatus 50, which differs from the programmable terminal 910. As described above, the duration taken before displaying a screen image in the screen image generation apparatus 50 can differ from the duration taken before displaying the screen image in the programmable terminal 910.

The screen image generation apparatus 50 with the structure described below allows a screen creator who generates a screen image to recognize this duration difference.

As shown in FIG. 2, the screen image generation apparatus 50 includes a calculation unit 10, a screen display duration database (DB) 20, an operation input unit 30, and the display 40.

The calculation unit 10 includes a screen generation unit 11 and a display duration calculation unit 12. The calculation unit 10 includes, for example, a computation unit such as a central processing unit (CPU), and programs. The programs include a screen generation program and a screen display duration calculation program. The computation unit executes the screen generation program to implement the functions of the screen generation unit 11. The computation unit executes the screen display duration calculation program to implement the functions of the display duration calculation unit 12. The screen generation unit 11 and the display duration calculation unit 12 may be implemented by separate pieces of hardware.

The screen generation unit 11 generates a screen image to be displayed by the programmable terminal 910 with a method described in detail later.

The operation input unit 30 receives an operation input for generating a screen image, and outputs information about the received operation input to the screen generation unit 11. The screen generation unit 11 generates a screen image in accordance with the information about the operation input.

The display duration calculation unit 12 calculates the duration (screen display duration) taken by the programmable terminal 910 before displaying the screen image generated by the screen generation unit 11. The display duration calculation unit 12 calculates the screen display duration using the screen display duration stored for each element in the screen display duration DB 20.

FIG. 3 is a diagram showing information stored in the screen display duration DB. As shown in FIG. 3, the screen display duration DB 20 stores the screen display duration for each element (element display duration). The element display duration is the duration taken by the programmable terminal 910 before displaying each single element. The element display duration for each element may be preliminary measured for each element using the programmable terminal 910.

More specifically, the screen display duration DB 20 stores the element name and the screen display duration in a manner associated with each other. As shown in FIG. 3, for example, an element name B11 is associated with a screen display duration T₁₁. An element name B12 is associated with a screen display duration T₁₂. An element name B13 is associated with a screen display duration T₁₃. An element name P21 is associated with a screen display duration T₂₁. An element name P22 is associated with a screen display duration T₂₂. An element name M41 is associated with a screen display duration T₄₁. An element name M42 is associated with a screen display duration T₄₂.

The display duration calculation unit 12 obtains the name of an element included in the screen image from the screen generation unit 11, and searches the screen display duration DB 20 to obtain the screen display duration associated with the obtained element name. The display duration calculation unit 12 adds up the screen display durations for all the elements that are included in the screen image to calculate a screen display duration TD.

The screen display duration TD can be used to allow the screen creator to recognize the duration taken by the programmable terminal 910 before displaying the screen image. The screen display duration TD can also be used to allow the screen creator to recognize that the programmable terminal 910 will take a longer duration than a predetermined duration before displaying a predetermined screen image.

The screen display duration TD is the duration taken before a screen image is displayed, from when no image is on the screen. In switching between a plurality of screen images, the duration taken to switch from a previous screen image to a current screen image, or specifically the duration taken to change the display is substantially the same as the screen display duration TD. The duration taken to change the display can also be treated in the same manner as the screen display duration TD described below.

A method for generating a screen image and a method for notifying the screen display duration TD or providing a warning notification will now be described.

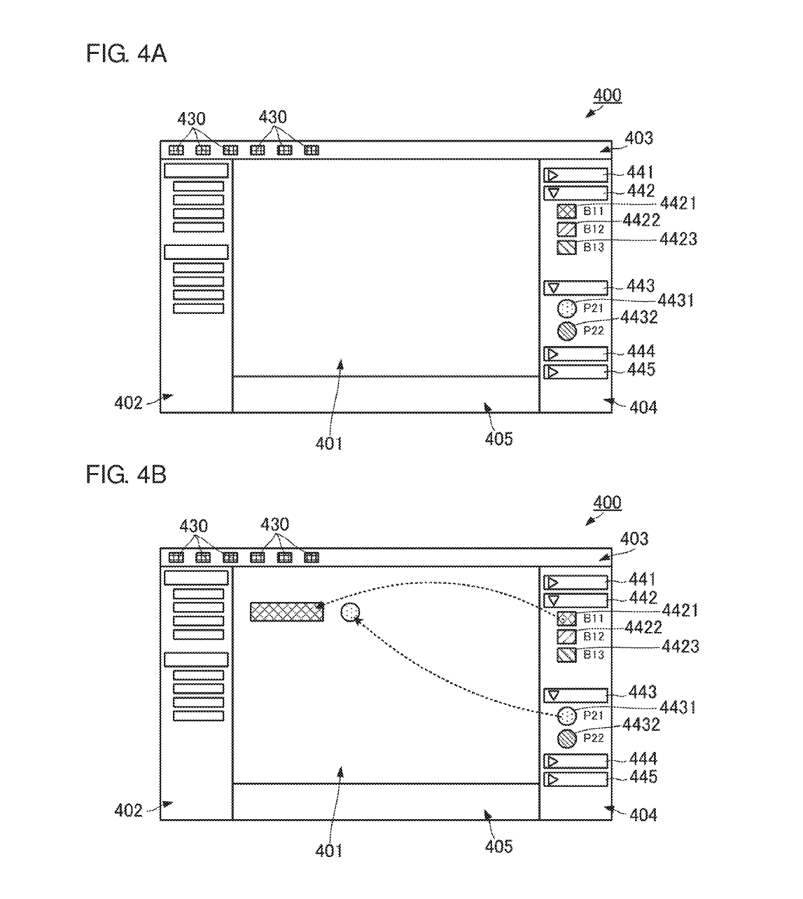

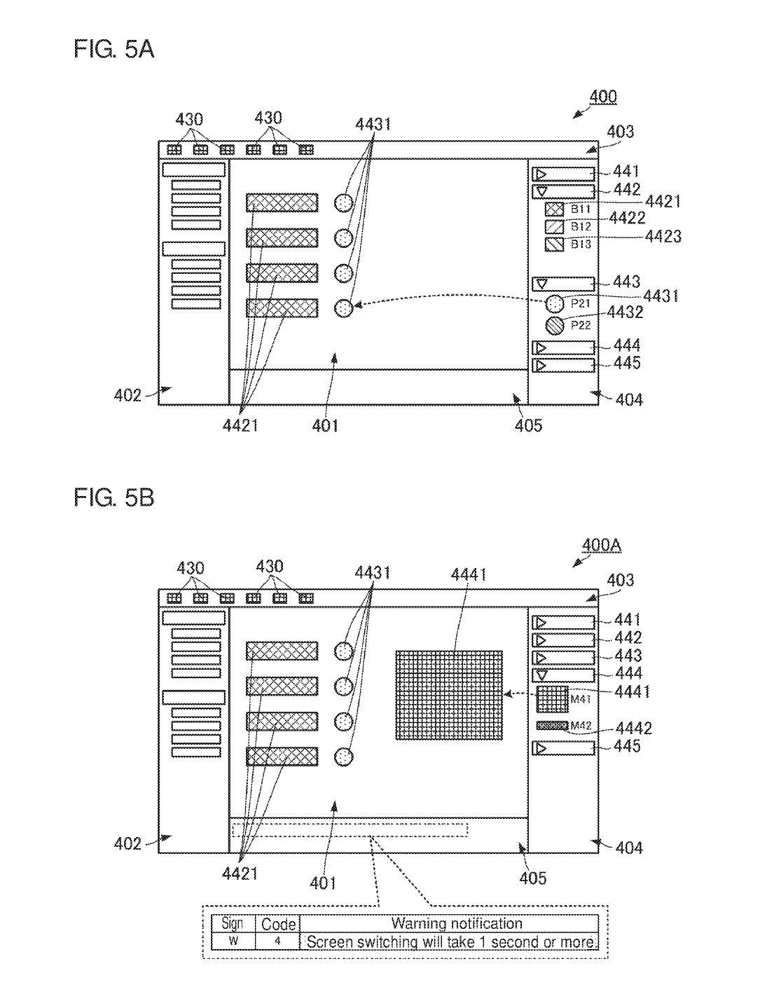

FIG. 4A is a schematic diagram showing the structure of a displayed screen for generating a screen image. FIG. 4B is a diagram describing screen image generation in a first state. FIG. 5A is a diagram describing screen image generation in a second state. FIG. 5B is a diagram describing screen image generation in a third state.

A screen 400, which is used by the screen generation unit 11 to generate a screen image, appears on the display 40 of the screen image generation apparatus 50. As shown in FIG. 4A, the screen 400 includes a screen generation window 401, an explorer window 402, a tool bar 403, a tool box window 404, and a build window 405. The screen generation window 401 shows a screen image to be generated, which is a screen image to be displayed by the programmable terminal 910. The explorer window 402 includes items including settings for the screen image, and selection bars for selecting screen images. The tool bar 403 includes a plurality of icons 430 for representing frequently used functions for screen image generation. The build window 405 shows, for example, any error message that may be generated when the build is complete, or specifically when each icon in the screen image generated by the screen generation window 401 is linked to its function to generate a file to be transferred to the programmable terminal 910.

The tool box window 404 includes bars 441, 442, 443, 444, and 445, which categorize the elements of the screen image (e.g., buttons, lamps, and measuring instruments). The tool box window 404 further includes icons representing the elements in correspondence with the bars, and their element names. Each icon has its element name. For example, the bar 442 for buttons includes icons 4421, 4422, and 4423 each representing a button. The icon 4421 has an element name B11. The icon 4422 has an element name B12. The icon 4423 has an element name B13. The bar 443 for lamps includes icons 4431 and 4432 each representing a lamp. The icon 4431 has an element name P21. The icon 4432 has an element name P22. The bar 444 for measuring instruments includes icons 4441 and 4442 each representing a measuring instrument. The icon 4441 has an element name M41. The icon 4442 has an element name M42.

Each icon on the tool box window 404 can be dragged and dropped with an operation performed using the operation input unit 30. As shown in FIG. 4B, for example, the icon 4421 is selected and is placed at a predetermined position on the screen generation window 401 to generate a screen image including the icon 4421 representing the element B11 placed at the predetermined position. In the same manner, as shown in FIG. 4B, the icon 4431 is selected and placed at another predetermined position on the screen generation window 401 to generate a screen image including the icon 4431 representing the element P21 placed at the other predetermined position.

In this structure, when the screen generation unit 11 places the icon 4421 on the screen generation window 401 as shown in FIG. 4B, the display duration calculation unit 12 detects the element name B11 from the icon 4421 and obtains, from the screen display duration DB 20, the screen display duration T₁₁ associated with the element name B11. In the same manner, when the screen generation unit 11 places the icon 4431 on the screen generation window 401 as shown in FIG. 4B, the display duration calculation unit 12 detects the element name P21 from the icon 4431 and obtains, from the screen display duration DB 20, the screen display duration T₂₁ associated with the element name P21.

The display duration calculation unit 12 adds up the screen display duration T₁₁ for the icon 4421 and the screen display duration T₂₁ for the icon 4431 to calculate the screen display duration TD.

The process for calculating the screen display duration TD is continued until screen image generation for the screen generation window 401 is complete. For each change in the number of icons placed on the screen generation window 401, the screen display duration TD is updated.

For example, the screen image changes from the state shown in FIG. 4B to the state in FIG. 5A, and four icons 4421 and four icons 4431 are placed on the screen generation window 401. The display duration calculation unit 12 adds up the screen display duration T₁₁ multiplied by four (four icons 4421), or T₁₁*4, and the screen display duration T₂₁ multiplied by four (four icons 4431), or T₂₁*4. The resultant value is used to update the screen display duration TD.

The screen image changes from the state shown in FIG. 5A to the state in FIG. 5B, and four icons 4421, four icons 4431, and one icon 4441 are placed on the screen generation window 401. The display duration calculation unit 12 adds up the screen display duration T₁₁ multiplied by four (four icons 4421), or T₁₁*4, the screen display duration T₂₁ multiplied by four (four icons 4431), or T₂₁*4, and the screen display duration T₄₁ (one icon 4441). The resultant value is used to update the screen display duration TD.

In the state shown in FIG. 5B, the screen display duration TD is not less than a preset threshold duration Tth (one second in the example of FIG. 5B). The display duration calculation unit 12 detects that the screen display duration TD is not less than the threshold duration Tth and displays information indicating that the screen display duration TD is not less than the threshold duration Tth on the build window 405. In the example of FIG. 5B, for example, the build window 405 displays a warning sign of W, an identification code of 4, and a warning notification indicating that screen image switching will take at least one second. The screen creator viewing the screen 400 can then recognize that displaying the current screen image with the programmable terminal 910 will take at least the threshold duration Tth.

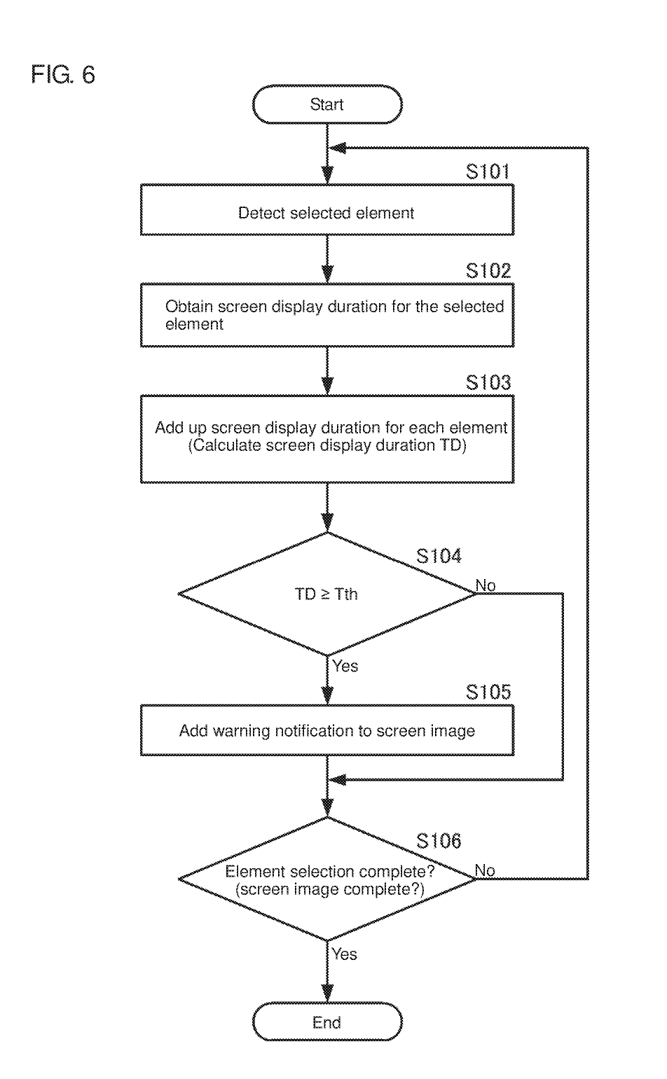

This process can be implemented by the calculation unit 10 executing a program describing the procedure shown in FIG. 6. FIG. 6 is a flowchart showing a screen image generation method according to the first embodiment of the present invention.

The calculation unit 10 first detects an element selected for screen image generation (S101). More specifically, the calculation unit 10 detects an element placed on the screen generation window 401.

The calculation unit 10 obtains, from the screen display duration DB 20, the screen display duration associated with the selected element (S102). The calculation unit 10 adds up the screen display duration for each element to calculate the screen display duration TD (S103).

The calculation unit 10 compares the screen display duration TD with the threshold duration Tth. The threshold duration Tth is the preset duration to be taken by the programmable terminal 910 before displaying the screen image. The threshold duration Tth is set to the shortest duration that causes an operator of the programmable terminal 910 to feel that the screen display is slow. When detecting that the screen display duration TD is not less than the threshold duration Tth (Yes in S104), the calculation unit 10 adds a warning notification to the screen image (S105). More specifically, the calculation unit 10 displays a warning notification on the build window 405 in the screen 400.

When detecting that the screen display duration TD is less than the threshold duration Tth (No in S104), the calculation unit 10 provides no warning notification.

When the element selection is not complete (No in S106), the calculation unit 10 returns the processing to step S101 and continues the screen generation process. When determining that the element selection is complete (the screen image is complete) (Yes in S106), the calculation unit 10 performs the build process and stores a file to be transferred to the programmable terminal 910. The build process is performed based on the configuration of the screen generation window 401. Thus, the file may not include a warning notification.

A screen image generation apparatus, a screen image generation method, and a screen image generation program according to a second embodiment of the present invention will now be described.

The screen image generation apparatus, the screen image generation method, and the screen image generation program according to the second embodiment differ from the screen image generation apparatus, the screen image generation method, and the screen image generation program according to the first embodiment in the method for notifying the screen display duration TD. The other parts of the screen image generation apparatus, the screen image generation method, and the screen image generation program according to the second embodiment are the same as those described in the first embodiment, and will not be described.

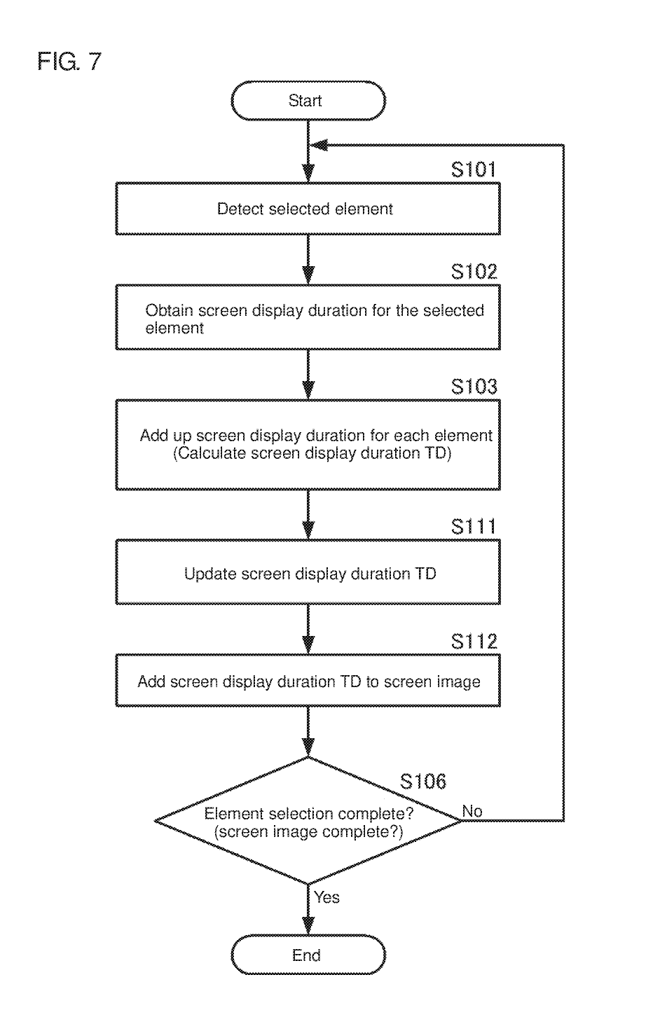

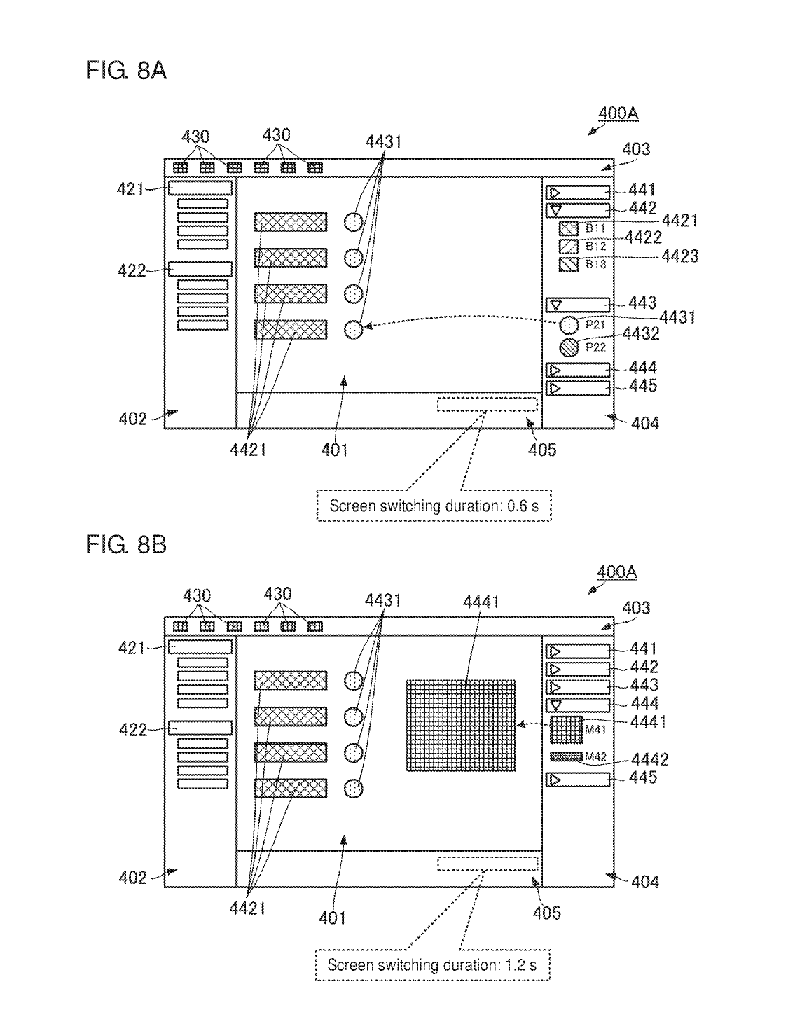

FIG. 7 is a flowchart showing the screen image generation method according to the second embodiment. FIG. 8A is a diagram describing screen image generation in a first state with the screen image generation method according to the second embodiment. FIG. 8B is a diagram describing screen image generation in a second state with the screen image generation method according to the second embodiment.

Steps S101 to S103 in FIG. 7 are the same as steps S101 to S103 in FIG. 6, and will not be described.

The calculation unit 10 stores the screen display duration TD. When a new screen display duration TD is calculated, the calculation unit 10 updates the record (S111).

The calculation unit 10 adds the updated screen display duration TD to the screen image (S112). More specifically, the calculation unit 10 displays the updated screen display duration TD on the build window 405 in the screen 400.

In the example of FIG. 8A, when four icons 4421 and four icons 4431 are placed on the screen generation window 401, the calculation unit 10 adds up the screen display duration T₁₁ multiplied by four (four icons 4421), or T₁₁*4, and the screen display duration T₂₁ multiplied by four (four icons 4431), or T₂₁*4, and uses the resultant sum to update the screen display duration TD. The calculation unit 10 displays the updated screen display duration TD on the build window 405. In FIG. 8A, for example, the build window 405 displays the screen image switching duration of 0.6 s. The screen image switching duration is defined using the same duration as the screen display duration TD.

In the example of FIG. 8B, one icon 4441 is further placed on the screen generation window 401 in addition to the icons in the example of FIG. 8A. The calculation unit 10 adds up the screen display duration T₁₁ multiplied by four (four icons 4421), or T₁₁*4, the screen display duration T₂₁ multiplied by four (four icons 4431), or T₂₁*4, and the screen display duration T₄₁ (one icon 4441), and uses the resultant sum to update the screen display duration TD. The calculation unit 10 displays the updated screen display duration TD on the build window 405. In FIG. 8B, for example, the build window 405 displays the screen image switching duration of 1.2 s.

Through this processing, the screen creator can check the screen display duration TD as appropriate while generating a screen image, or for example, adding an element. In the same manner as in the above embodiment, the build process is performed based on the configuration of the screen generation window 401. Thus, the file may not include the screen display duration TD.

A screen image generation apparatus, a screen image generation method, and a screen image generation program according to a third embodiment will now be described.

The screen image generation apparatus, the screen image generation method, and the screen image generation program according to the third embodiment differ from the screen image generation apparatus, the screen image generation method, and the screen image generation program according to each of the first and second embodiments in that the screen display duration for each group is added to the screen. The other parts of the screen image generation apparatus, the screen image generation method, and the screen image generation program according to the third embodiment are the same as those described in the first and second embodiments, and will not be described.

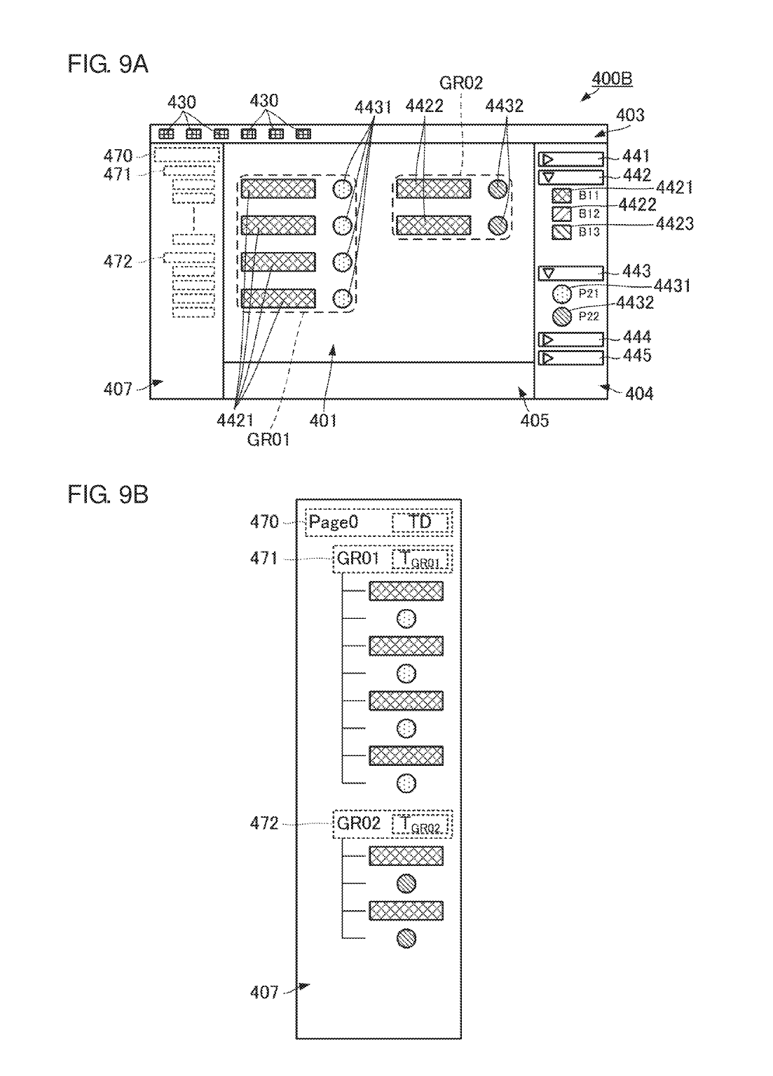

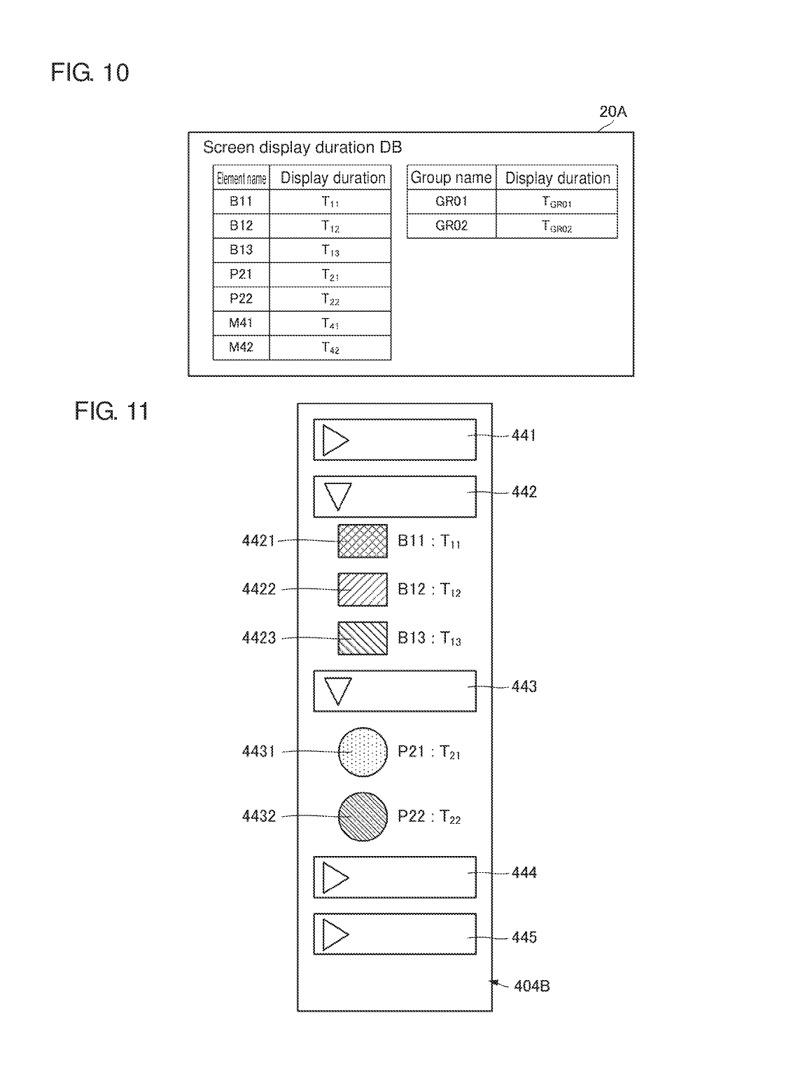

FIG. 9A is a schematic diagram showing the structure of a displayed screen for generating a screen image. FIG. 9B shows the structure of a display window for groups. FIG. 10 is a diagram showing information stored in a screen display duration DB according to the third embodiment.

As shown in FIG. 9A, a screen 400B includes a group display window 407, in addition to the screen generation window 401, the tool bar 403, the tool box window 404, and the build window 405.

As shown in FIG. 9B, the group display window 407 includes a page display bar 470 indicating a page of the current screen image appearing on the screen generation window 401, and group display bars 471 and 472.

The page display bar 470 displays the page number of the current screen image appearing on the screen generation window 401 and the screen display duration TD.

The group display bar 471 displays a screen display duration T_{GR01} for a group GR01. An icon group (four icons 4421 and four icons 4431 in the example of FIG. 9A) included in the group GR01 is displayed in a manner associated with the group display bar 471. The screen display duration T_{GR01} for the group GR01 is calculated based on the total of the screen display duration for each icon of the icon group included in the group GR01. As shown in FIG. 10, a screen display duration DB 20A stores the screen display duration T_{GR01} in a manner associated with the group GR01.

The group display bar 472 displays a screen display duration T_{GR02} for a group GR02. An icon group (two icons 4422 and two icons 4432 in the example of FIG. 9A) included in the group GR02 is displayed in a manner associated with the group display bar 472. The screen display duration T_{GR02} for the group GR02 is calculated based on the total of the screen display duration for each icon of the icon group included in the group GR02. As shown in FIG. 10, a screen display duration DB 20A stores the screen display duration T_{GR02} in a manner associated with the group GR02.

The group display bars 471 and 472 can be dragged and dropped onto the screen generation window 401, in the same manner as for the elements. The display duration calculation unit 12 obtains, from the screen display duration DB 20A, the screen display duration for the group GR appearing on the screen generation window 401, and uses the obtained duration to calculate the screen display duration TD.

This allows calculation of the screen display duration TD in screen generation using the group GR, without obtaining the screen display duration for each element included in the group GR.

This structure also allows the screen creator to easily check the screen display duration for each group GR.

As shown in FIG. 11, the tool box window may display the screen display duration for each element. FIG. 11 is a schematic diagram of a tool box window.

As shown in FIG. 11, a tool box window 404A displays the screen display duration for each element, together with the element name. This structure allows the screen creator to easily check the screen display duration for each element.

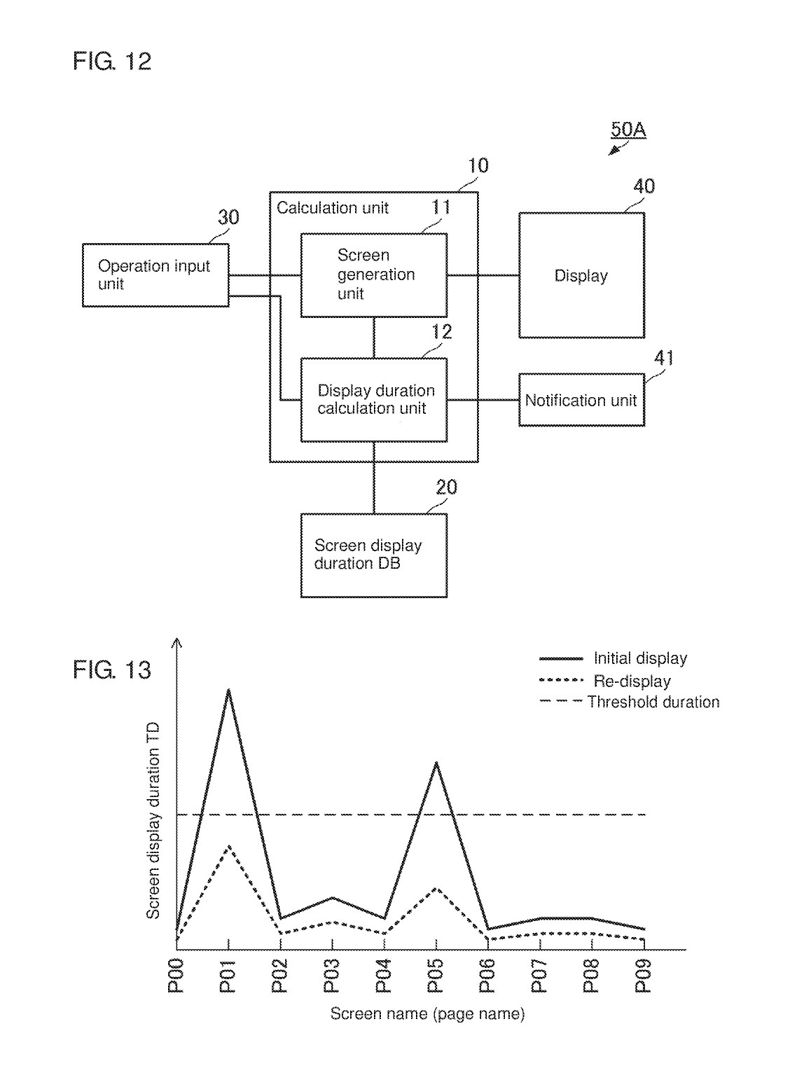

A screen image generation apparatus, a screen image generation method, and a screen image generation program according to a fourth embodiment of the present invention will now be described. FIG. 12 is a block diagram showing the main elements of the screen image generation apparatus according to the fourth embodiment of the present invention.

The screen image generation apparatus, the screen image generation method, and the screen image generation program according to the fourth embodiment differ from the screen image generation apparatus, the screen image generation method, and the screen image generation program according to each of the first, second, and third embodiments in that a notification unit (notification process) is added. The other parts of the screen image generation apparatus, the screen image generation method, and the screen image generation program in the fourth embodiment are the same as those described in the first, second, and third embodiments, and will not be described. The structure of the screen image generation apparatus will be described, and the other categories, or the method and the program, will not be described.

A screen image generation apparatus 50A includes a notification unit 41, in addition to the components of the screen image generation apparatus 50.

The display duration calculation unit 12 stores the screen display duration TD for each screen image generated by the screen generation unit 11. In response to an instruction from the operation input unit 30 to output the screen display duration TD for a plurality of screen images, the display duration calculation unit 12 outputs the screen display duration TD for each screen image to the notification unit 41.

The notification unit 41 uses the screen display duration TD for each of the plurality of screen images, and generates a file listing the screen display duration TD for each screen image. FIG. 13 is a graph showing an example file listing the screen display duration TD for each screen image generated by the notification unit 41. In FIG. 13, the horizontal axis shows the name of each screen image (page name), and the vertical axis shows the screen display duration TD. The solid line represents the screen display duration TD for an initially displayed screen image, and the dotted line represents the screen display duration TD for a re-displayed screen image. The broken line indicates the threshold duration.

The file showing the graph is output. The screen creator referring to the graph can easily check the screen display duration TD for each screen image. As shown in FIG. 13, the threshold duration also appears to allow the screen creator to easily identify a screen image that takes a display duration longer than the threshold duration. The screen creator can also check the screen display duration TD for each screen image when the image is re-displayed.

The screen display duration for the re-display and the threshold duration may not be displayed. The screen display duration for the re-display may be calculated by preliminary obtaining the screen display duration for each element for the re-display, in the same manner as for the screen display duration TD at the initial display.

The notification unit 41 may be a sound producing device, such as a loudspeaker, to provide a warning sound.

A screen image generation apparatus, a screen image generation method, and a screen image generation program according to a fifth embodiment of the present invention will now be described.

The screen image generation apparatus, the screen image generation method, and the screen image generation program according to the fifth embodiment differ from the screen image generation apparatus, the screen image generation method, and the screen image generation program according to each of the first, second, and third embodiments in that display of a generated screen image is simulated. The other parts of the screen image generation apparatus, the screen image generation method, and the screen image generation program in the fifth embodiment are the same as those described in the first, second, and third embodiments, and will not be described.

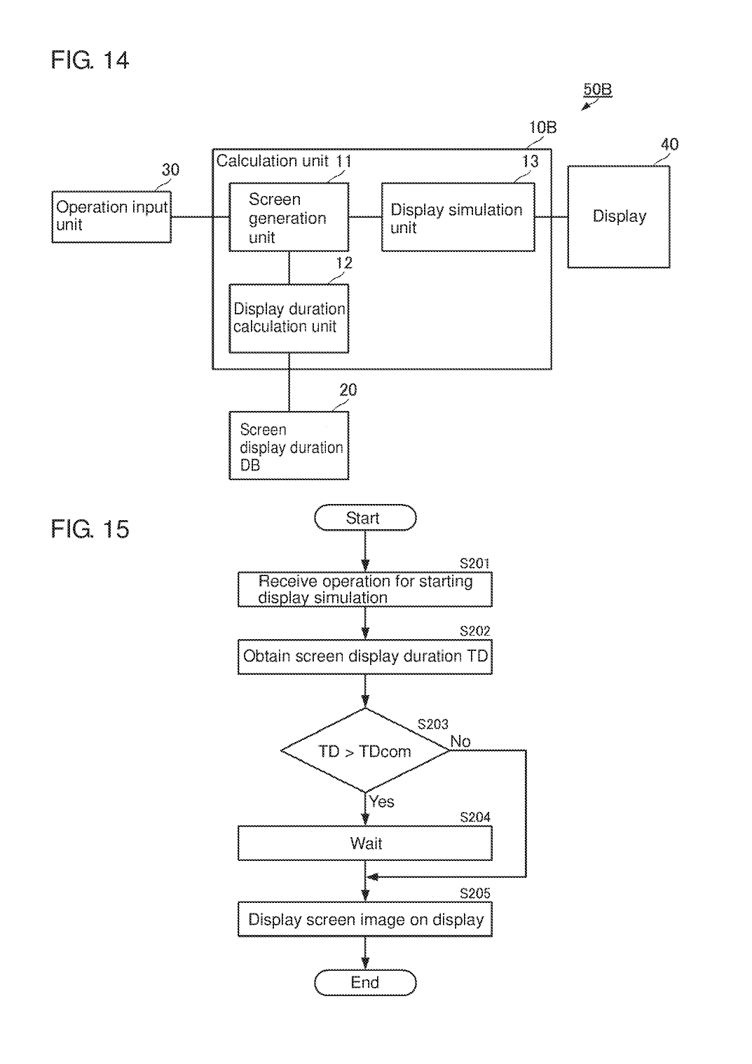

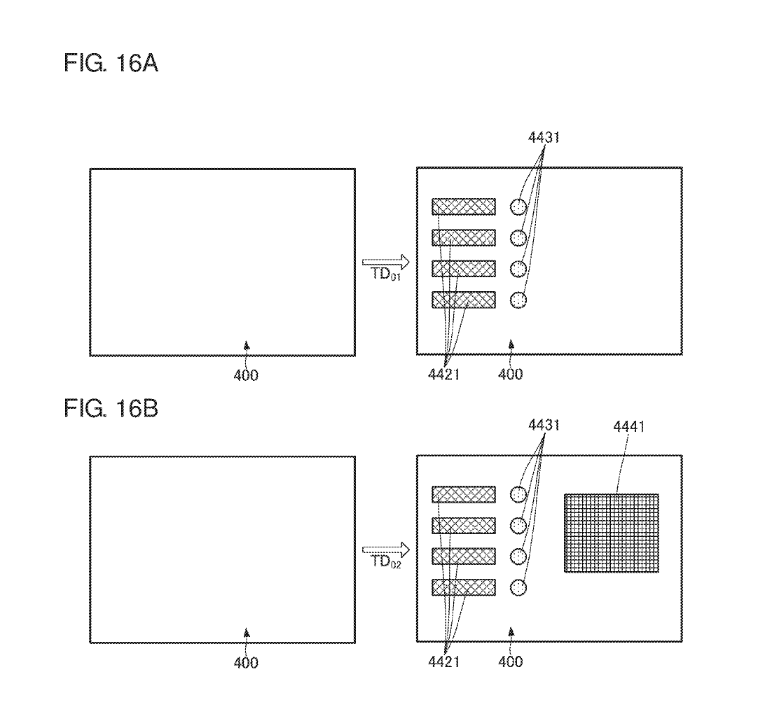

FIG. 14 is a block diagram of the screen image generation apparatus according to the fifth embodiment of the present invention. FIG. 15 is a flowchart showing a process for checking a generated screen image according to the fifth embodiment using a simulator. FIGS. 16A and 16B are diagrams each describing a screen image appearing on a display. FIG. 16A differs from FIG. 16B in the elements included in a screen image completed on the screen generation window 401.

As shown in FIG. 14, a screen image generation apparatus 50B includes a calculation unit 10B, which includes a display simulation unit 13 in addition to the components of the calculation unit 10 according to each of the above embodiments. The display simulation unit 13 is connected to the screen generation unit 11 and the display 40. The display simulation unit 13 performs the processing described below.

The calculation unit 10B receives an operation for starting a display simulation through the operation input unit 30 (S201). The calculation unit 10B obtains the screen display duration TD for each screen image stored in the display duration calculation unit 12 (S202).

The calculation unit 10B compares the screen display duration (the screen display duration for the programmable terminal 910) TD with a screen display duration TDcom for the screen image generation apparatus. When the screen display duration TD is longer than the screen display duration TDcom (Yes in S203), the calculation unit 10B sequentially performs the processing of steps S204 and S205. More specifically, the display simulation unit 13 in the calculation unit 10B waits for the screen display duration TD (S204), and displays a screen image on the display 40 (S205). This wait time may be set precisely to the time obtained by subtracting the screen display duration TDcom from the screen display duration TD.

When the screen display duration TD is equal to or shorter than the screen display duration TDcom (No in S203), the calculation unit 10B does not perform the waiting process. The display simulation unit 13 displays a screen image on the display 40.

In the examples shown in FIGS. 16A and 16B, for example, the screen display durations TD₀₁ and TD₀₂ are both longer than the screen display duration TDcom. In the example of FIG. 16A, the display simulation unit 13 displays an image on the screen image 400 of the display 40 after the wait time, or the screen display duration TD₀₁, passes from when no image is on the screen image 400 of the display 40. In the example of FIG. 16B, the display simulation unit 13 displays an image on the screen image 400 of the display 40 after the wait time, or the screen display duration TD₀₂, passes from when no image is on the screen image 400 of the display 40.

Through this processing, the screen creator can easily check the actual view of the screen image in the programmable terminal 910.

To display a plurality of screen images in this simulation, the waiting process of waiting for the above screen display duration TD may be performed when the screen images are switched. This allows the screen creator to easily check the view of the screen image when the screen images are switched.

Although the above embodiments describe the programmable terminal 910 as one example of an external device of the screen image generation apparatus, the above structure is applicable to another device including the display to produce the same advantageous effects as described above.

### REFERENCE SIGNS LIST

10, 10B calculation unit
11 screen generation unit
12 display duration calculation unit
13 display simulation unit
20, 20A screen display duration DB
30 operation input unit
40 display
41 notification unit
50, 50A, 50B screen image generation apparatus
90 FA system
400, 400B screen
401 screen generation window
402 explorer window
403 tool bar
404 tool box window
404A tool box window
405 build window
407 group display window
430, 4421, 4422, 4423, 4431, 4432, 4441, 4442 icon
441, 442, 443, 444 bar
470 page display bar
471 group display bar
900 FA device
910 programmable terminal
471, 472 group display bar

1. A screen image generation apparatus, comprising:
a screen generation unit configured to generate a screen image to be displayed by an external device;
a screen display duration database configured to store an element display duration for an element included in the screen image, the element display duration being a duration to be taken by the external device before displaying each element; and
a display duration calculation unit configured to calculate, using the element display duration, a screen display duration taken by the external device before displaying the generated screen image.

2. The screen image generation apparatus according to claim 1, wherein
the screen generation unit adds the screen display duration to the screen image.

3. The screen image generation apparatus according to claim 2, wherein
when detecting that the screen display duration is not less than a preset threshold duration, the display duration calculation unit outputs a warning notification to the screen generation unit, and
the screen generation unit adds the warning notification to the screen image.

4. The screen image generation apparatus according to claim 1, wherein
when detecting that the screen display duration is not less than a preset threshold duration, the display duration calculation unit provides a warning notification.

5. The screen image generation apparatus according to claim 1, wherein
the screen display duration database stores a group display duration for a group including a plurality of elements, the group display duration being a duration to be taken by the external device before displaying a screen image including the group, and
when the group is included in the screen image, the display duration calculation unit calculates, using the group display duration, the screen display duration.

6. The screen image generation apparatus according to claim 1, wherein
the screen generation unit adds the group display duration to the screen image.

7. The screen image generation apparatus according to claim 1, wherein
the screen generation unit adds the element display duration to the screen image.

8. The screen image generation apparatus according to claim 1, wherein
the display duration calculation unit stores a screen display duration for a screen image, and outputs a list including the screen display duration for each screen image.

9. The screen image generation apparatus according to claim 1, further comprising:
a display simulation unit configured to simulate display of the screen image,
wherein the display simulation unit outputs the screen image after a wait time that is set in accordance with the screen display duration.

10. A screen image generation method, comprising:
generating a screen image to be displayed by an external device; and
calculating a screen display duration taken by the external device before displaying the generated screen image using an element display duration to be taken by the external device before displaying an element included in the screen image.

11. A non-transitory computer readable medium having a screen image generation program stored therein, the screen image generation program causing an information processing apparatus to implement:
generating a screen image to be displayed by an external device; and
calculating a screen display duration taken by the external device before displaying the generated screen image using an element display duration to be taken by the external device before displaying an element included in the screen image.
